(19) United States
(12) Patent Application Publication
(10) Pub. No.: US 2009/0047102 A1
(43) Pub. Date: Feb. 19, 2009

(54) Device for charging alternative fuels into a rotary kiln and method for charging such alternative fuels and/or waste products

(75) Inventors: Leo Seirlehner, Linz (AT); Jochen Aigner, Ottnang (AT)

Correspondence Address: CHAPMAN AND CUTLER, 111 WEST MONROE STREET, CHICAGO, IL, 60603, US

(73) Assignee: Holcim (Slovensko) a.s., Rohoznik (SK)

(21) Appl. No.: 11/920,172

(22) PCT Filed: May 11, 2006
(86) PCT No.: PCT/AT2006/000198

§ 371 Date: Oct. 9, 2008

(30) Foreign Application Priority Data
May 11, 2005 (AT) GM 318/2005

(51) Int. Cl. F27B 7/18

(52) U.S. Cl. 414/149

(57) ABSTRACT

In a device for charging lumpy alternative fuels and/or waste products into a rotary kiln at a location situated between the charging end and the discharging end of the rotary kiln, wherein a closable opening is provided in the jacket of the rotary kiln, the opening carries an inwardly opening flap which is spring-loaded in the sense of closing, and a lifting device such as, e.g., a fork adjoins the opening in a substantially radial direction, from which lifting device the fuels or waste products to be charged are dischargeable into the rotary kiln under the action of gravity while overcoming the closing force of the flap.

The invention relates to a device for charging lumpy alternative fuels and/or waste products into a rotary kiln at a location situated between the charging end and the discharging end of the rotary kiln, wherein a closable opening is provided in the jacket of the rotary kiln, as well as a method for charging alternative fuels and/or waste products in lumpy form, in particular used tires, into a rotary kiln via a charging opening passing through the jacket of the rotary kiln.

Alternative fuels and, in particular, waste substances are characterized by their inhomogeneous burning behaviour, whereby inflammable organic components and, in particular, combustible portions liberated in gaseous form at elevated temperatures will preferably burn in a different way than remaining combustible solids. For this reason, it has already been proposed in DE A 3524316 to carry out a previous separation of such alternative fuels or waste products into organic and inorganic portions and charge the same into the kiln at different locations. EP 462972 B1 tries to charge such decomposable products into a rotary kiln in a simple manner at one site only, to which end it is proposed to fill the fuels into containers and charge the furnace with the wastes contained in the containers. Such a mode of procedure will considerably facilitate charging, since a simple supply channel can be provided, which is adaptable to the shape of the respective receptacle. It will subsequently do to effect charging at a location, based on the length of the kiln cylinder, at which the gas temperature within the kiln will suffice to decompose the volatile components of the wastes, whereby the solid portions introduced through the charging opening are to enter into contact with the mineral calcining material. The device proposed for that purpose comprises a closable opening whose closure is force-controlled as a function of the rotational position of the rotary kiln and is, for instance, opened on the highest point and closed again after this so as to enable the container or canister to be subsequently introduced into the rotary kiln through a down-pipe.

The invention aims to charge lumpy alternative fuels and/or waste products without additional manipulation and, in particular, without packaging into containers, and, at the same time, provide a particularly simple charging opening configuration that does not require any external force-control for opening and closing the opening.

To solve this object, the device according to the invention, of the initially defined kind essentially consists in that the opening carries an inwardly opening flap which is spring-loaded in the sense of closing, and that a lifting device such as, e.g., a fork adjoins the opening in a substantially radial direction, from which lifting device the fuels or waste products to be charged are dischargeable into the rotary kiln under the action of gravity while overcoming the closing force of the flap. By providing a simple flap which opens inwardly and is powered or spring-loaded in the sense of closing, the configuration can be balanced or equilibrated in a manner that the spring force is smaller than the weight of the lumpy waste products to be charged so as to cause to flap to open under the action of gravity and the weight of the materials to be charged in order to close again immediately thereupon. And by providing, at the opening, a lifting means which may, in particular, be designed in a fork-like manner, the facility is provided to simply push the waste product or lumpy alternative fuel onto such a fork adjoining the opening in a substantially radial direction, whereupon the alternative fuels or waste products will be seized by the fork to be taken along, in the same sense of rotation as the sense of rotation of the rotary kiln, as far as to the highest position, from where they will then be able to reach the interior of the rotary kiln while overcoming the closing force of the flap. As already mentioned, the closing force of the flap is in this case designed such that the fuels or waste products to be charged can each be discharged into the rotary kiln under the action of gravity and while overcoming the closing force of the flap.

In a particularly simple manner, the lifting device may comprise prongs capable of being moved through the interspaces of the prongs of a stationary conveying device, wherein the clear width between neighboring prongs of the lifting device is smaller than the respective width of the lumpy fuels or waste products resting thereon and to be conveyed and lifted. Such prongs of the lifting device, which can be moved through stationary, neighboring prongs, serve to safely seize, for instance, used tires or other lumpy waste products whose dimensions each have to be larger than the clear width between the fork prongs, in order to prevent them from falling through. In principle, charging onto such a lifting fork will naturally only be feasible if the fork has not been lifted too much and, therefore, is able to safely seize an object resting on the stationary prongs, such as, for instance, used tires. To this end, the configuration is advantageously devised such that sensors for detecting the angular position of the lifting device relative to the axis of rotation of the rotary kiln are provided, and that the stationary conveying device and/or a slide for delivering the lumpy fuels and/or waste products onto the lifting device are actuatable as a function of the angular position of the lifting device so as to ensure that a collision of the prongs with not yet pushed-on waste products will actually be safely prevented.

It is to be taken into account, in particular when charging vehicle tires, that different tire dimensions will not only entail different sizes but also different weights. In order to introduce substantially constant calorific values over time, an appropriate compensation should be taken, whereby it is feasible, particularly in the event of small tires, to introduce two tires at the same time, whereas only one tire is to be introduced in the event of large tires. The configuration in this respect is advantageously devised such that scales and/or a sensor detecting a lump size are arranged upstream of the site of delivery onto the lifting device, and that the slide for delivering the lumpy fuels and/or waste products is actuatable as a function of the measured values of the scales and/or the lump-size detecting sensor.

In order to ensure that an appropriate number of used tires or lumpy waste products will always be kept in store, the configuration is advantageously devised such that the stationary conveying device, as a temporary storage, is equipped with sensors detecting a position of the material to be charged near the site of delivery onto the lifting device.

The preferred method for charging used tires into a rotary kiln according to the invention is essentially characterized in that the lump size and/or the lump weight of the fuels and/or waste products are detected, and charging into the rotary kiln is effected as a function of the detected measurements and the angular position of the charging opening in rotating operation. The lump weight and/or the lump size are, thus, taken into consideration for charging and, in the event of smaller tires, twice the amount of tires is, for instance, supplied in a charging procedure as would be supplied in the event of accordingly larger and heavier tires. Bearing in mind the tact that used tires, as a rule, comprise steel reinforcements, it is of particular advantage to effect charging at a location at which accordingly high temperatures prevail to melt metallic portions and/or cake them with mineral portions. To this end, the method is advantageously performed in a manner that charging is effected at a location in the rotary kiln, where the gas temperature exceeds 1100° C. and, in particular, 1200° C.

In the following, the invention will be explained in more detail by way of exemplary embodiments of the device according to the invention, which are schematically illustrated in the drawing. Therein:

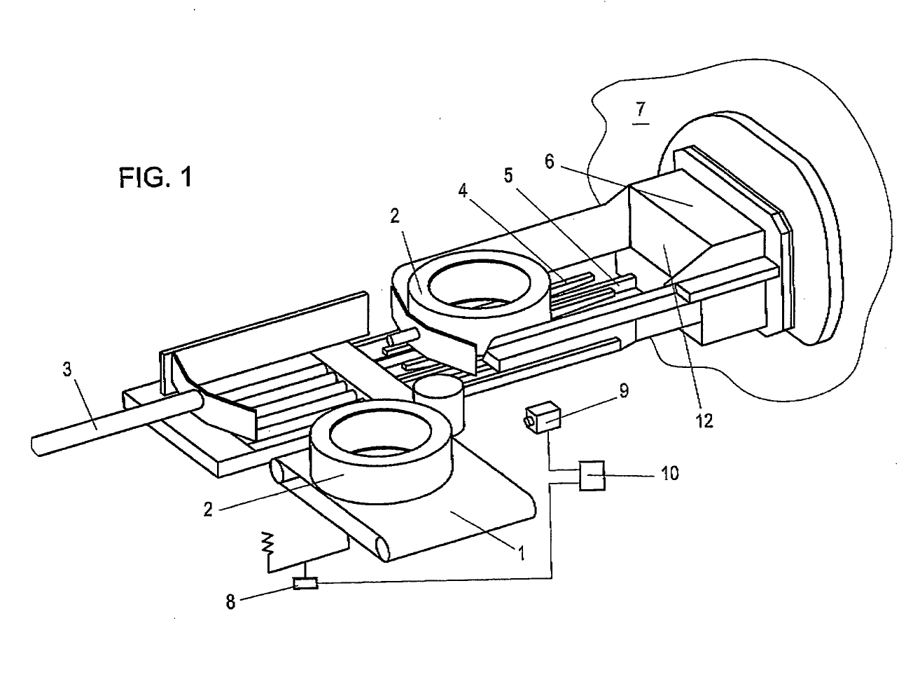

FIG. 1 is a perspective illustration of the supply device for used tires, including the lifting device attached to an opening of the rotary kiln;

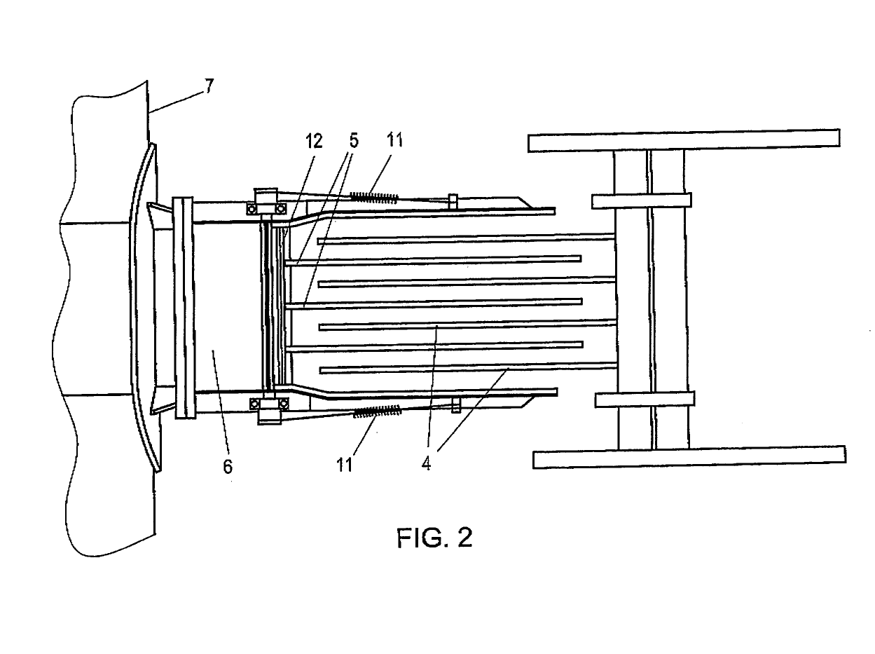

FIG. 2 is a top view on the lifting device and the stationary prongs of the supply device; and

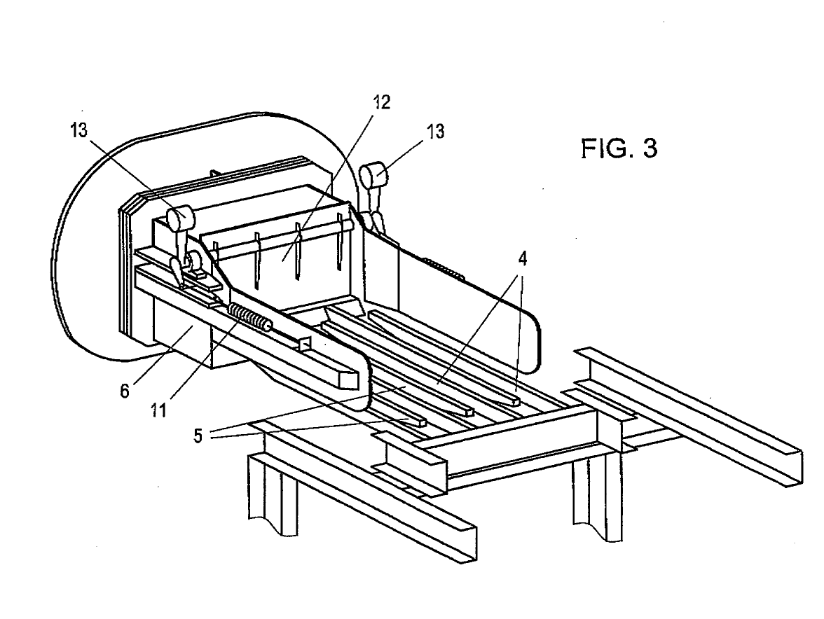

FIG. 3 is a perspective view of the illustration according to FIG. 2.

In FIG. 1, a stationary conveyor is denoted by 1, via which a tire 2 is conveyed to a delivery position with a slide 3, whereupon the slide 3 displaces the tire 2 onto the end of the stationary conveyor, i.e. prongs 4, as indicated. Through the interspaces of the prongs 4 emerge prongs 5 which are part of a lifting device that is connected with a closable opening 6 provided in the jacket 7 of a rotary kiln. In addition, the conveying device 1 comprises scales 8 and a camera 9, wherein the signals of the scales 8 and the camera 9 are analyzed and evaluated in an evaluation device 10 in order to control the drive of the conveying device 1. The weight and size of the used tires 2 are, thus, scanned to convey to the lifting device just one, or two, used tires at a time. The details of this lifting device are illustrated in FIG. 2 on an enlarged scale. FIG. 2 again depicts the prongs or forks 4 of the stationary conveying device, through which the prongs or forks 5 of the lifting device emerge. Furthermore, springs 11 are apparent from FIG. 2, which serve to maintain a flap 12 provided on the jacket 7 of the rotary kiln in its closed position. Pivoting of the prongs 5 together with the flap 12 into the respectively highest position enables a tire resting on the prongs 5 to activate the flap 12 in the sense of opening under the action of gravity, while overcoming the force of the springs 11, such that the tire will be able to enter the interior of the rotary kiln.

From FIG. 3, this is apparent from a perspective illustration, wherein the flap 12 is additionally contacted by counterweights to relieve the springs 11. Apart from that, the reference numerals of FIGS. 1 and 2 have been retained.

1-7. (canceled)

8. A device for charging one or more of lumpy alternative fuels and waste products into a rotary kiln at a location situated between a charging end of the rotary kiln and a discharging end of the rotary kiln, comprising:
a closable opening provided in a jacket of the rotary kiln,
said opening being provided at a location situated between the charging end of the rotary kiln and the discharging end of the rotary kiln, and
said opening carrying an inwardly opening flap having a closing force exerted upon said flap by springs connected directly or indirectly to said flap, so as to bias said flap in an outward direction of closing of said opening, and
a lifting device mounted on said rotary kiln that adjoins the opening in a substantially radial direction,
wherein
said lifting device is configured to hold the one or more of fuels or waste products to be charged in a position to discharge through the opening into the rotary kiln by the force of gravity acting upon the fuels or waste products to overcome the closing force of the flap, as the rotary kiln rotates.

9. A device according to claim 8, further comprising
a stationary conveying device comprising prongs,
wherein
the lifting device is a fork comprising prongs configured to move through interspaces of the prongs of the stationary conveying device, and
neighboring prongs of the lifting device are mounted so that a clear width between said neighboring prongs is smaller than a respective width of the fuels or waste products to be conveyed and lifted on said neighboring prongs.

10. A device according to claim 8, further comprising
sensors positioned so as to detect an angular position of the lifting device relative to an axis of rotation of the rotary kiln, and
means for actuating one or more of a stationary conveying device and a slide for delivering the fuels or waste products to deliver the fuels or waste products onto the lifting device as a function of the angular position of the lifting device detected by the sensors.

11. A device according to claim 9, further comprising
sensors positioned so as to detect an angular position of the lifting device relative to an axis of rotation of the rotary kiln, and
means for actuating one or more of the stationary conveying device and a slide for delivering the fuels or waste products to deliver the fuels or waste products onto the lifting device as a function of the angular position of the lifting device detected by the sensors.

12. A device according to claim 8, further comprising
means for detecting lump sizes of the fuels or waste products, said means for detecting being arranged upstream of a site of delivery onto the lifting device,
a slide for delivering the fuels or waste products onto the lifting device, and
means for actuating said slide to deliver the fuels or waste products onto the lifting device as a function of the detected lump sizes of the fuels or waste products.

13. A device according to claim 8, further comprising
a scale positioned to detect a lump weight of the fuels or waste products, said scale being arranged upstream of a site of delivery onto the lifting device,
a slide for delivering the fuels or waste products onto the lifting device, and
means for actuating said slide to deliver the fuels or waste products onto the lifting device as a function of the detected lump weight of the fuels or waste products.

14. A device according to claim 12, further comprising
a scale positioned to detect a lump weight of the fuels or waste products, said scale being arranged upstream of the site of delivery onto the lifting device, and
means for actuating said slide to deliver the fuels or waste products onto the lifting device as a function of the detected lump weight of the fuels or waste products.

15. A device according to claim 9, further comprising
means for detecting lump sizes of the fuels or waste products, said means for detecting being arranged upstream of a site of delivery onto the lifting device,
a slide for delivering the fuels or waste products onto the lifting device, and
means for actuating said slide to deliver the fuels or waste products onto the lifting device as a function of the detected lump sizes of the fuels or waste products.

16. A device according to claim 9, further comprising
a scale positioned to detect a lump weight of the fuels or waste products, said scale being arranged upstream of a site of delivery onto the lifting device,
a slide for delivering the fuels or waste products onto the lifting device, and
means for actuating said slide to deliver the fuels or waste products onto the lifting device as a function of the detected lump weight of the fuels or waste products.

17. A device according to claim 15, further comprising
a scale positioned to detect a lump weight of the fuels or waste products, said scale being arranged upstream of the site of delivery onto the lifting device, and
means for actuating said slide to deliver the fuels or waste products onto the lifting device as a function of the detected lump weight of the fuels or waste products.

18. A device according to claim 8, further comprising
a stationary conveying device that is positioned and configured to temporarily store the fuels or waste products, and that comprises sensors positioned to detect a position of the fuels or waste products near a site of delivery onto the lifting device.

19. A device according to claim 9, wherein
the stationary conveying device is positioned and configured to temporarily store the fuels or waste products, and comprises sensors positioned to detect a position of the fuels or waste products near a site of delivery onto the lifting device.

20. A device according to claim 10, further comprising
a stationary conveying device that is positioned and configured to temporarily store the fuels or waste products, and that comprises sensors positioned to detect a position of the fuels or waste products near a site of delivery onto the lifting device.

21. A device according to claim 11, wherein
the stationary conveying device is positioned and configured to temporarily store the fuels or waste products, and comprises sensors positioned to detect a position of the fuels or waste products near a site of delivery onto the lifting device.

22. A device according to claim 12, further comprising
a stationary conveying device that is positioned and configured to temporarily store the fuels or waste products, and that comprises sensors positioned to detect a position of the fuels or waste products near a site of delivery onto the lifting device.

23. A device according to claim 14, further comprising
a stationary conveying device that is positioned and configured to temporarily store the fuels or waste products, and that comprises sensors positioned to detect a position of the fuels or waste products near a site of delivery onto the lifting device.

24. A method for charging one or more of lumpy alternative fuels and waste products into a rotary kiln at a location situated between a charging end of the rotary kiln and a discharging end of the rotary kiln, comprising the steps of:
effecting rotation of a rotary kiln which comprises
a closable opening provided in a jacket of the rotary kiln, said opening being provided at a location situated between the charging end of the rotary kiln and the discharging end of the rotary kiln, and said opening carrying an inwardly opening flap having a closing force exerted upon said flap by springs connected directly or indirectly to said flap, so as to bias said flap in an outward direction of closing of said opening,
a lifting device mounted on said rotary kiln that adjoins the opening in a substantially radial direction, said lifting device being configured to hold the one or more of fuels or waste products to be charged in a position to discharge through the opening into the rotary kiln by the force of gravity acting upon the fuels or waste products to overcome the closing force of the flap, as the rotary kiln rotates,
sensors positioned so as to detect an angular position of the lifting device relative to an axis of rotation of the rotary kiln,
means for detecting one or more of lump sizes and lump weight of the fuels or waste products, said means for detecting being arranged upstream of a site of delivery onto the lifting device, and
means for actuating one or more of a stationary conveying device and a slide to deliver the fuels or waste products onto the lifting device, according to the detected angular position of the lifting device and to one or more of the detected lump sizes and lump weight of the fuels or waste products;
detecting the angular position of the lifting device;
detecting one or more of the lump sizes and lump weight; and
controlling the charging of the fuels or waste products into the rotary kiln in accordance with the detected angular position and with one or more of the detected lump sizes and lump weight.

25. The method according to claim 24, wherein the charging is effected at a location in the rotary kiln where a gas temperature exceeds 1100° C.

26. The method according to claim 25, wherein the charging is effected at a location in the rotary kiln where the gas temperature is approximately 1200° C.

27. The method according to claim 24, wherein the fuels or waste products are tires.
